(19) United States
(12) Patent Application Publication
(10) Pub. No.: US 2005/0150906 A1
(43) Pub. Date: Jul. 14, 2005

(54) Ice dispenser

(76) Inventors: Mika Ishigure, Aichi-ken (JP); Hideyuki Ikari, Aichi-ken (JP); Tomohito Nomura, Aichi-ken (JP)

Correspondence Address: WENDEROTH, LIND & PONACK, L.L.P., 2033 K STREET N. W., SUITE 800, WASHINGTON, DC, 20006-1021, US

(21) Appl. No.: 11/010,434

(22) Filed: Dec. 14, 2004

(30) Foreign Application Priority Data
Jan. 9, 2004 (JP) 2004-004626

(51) Int. Cl. B67D 5/62

(52) U.S. Cl. 222/146.6

(57) ABSTRACT

A projecting portion is provided to a discharge chute, the projecting portion having a substantially horizontal slope portion and a step portion that is connected to an end portion of the slope portion and extends in a downward direction. Ice within an ice storage bin can thus be prevented from spilling out, even when ice becomes trapped between the door and the projecting portion.

### BACKGROUND OF THE INVENTION

1. Field of the Invention

The present invention relates to an ice dispenser. In particular, the present invention relates to an ice dispenser having such a structure that an opening and closing door disposed in a discharge port of an ice storage bin is opened to discharge chip ice.

2. Description of the Related Art

Conventionally, this type of ice dispenser has a refrigeration casing that is a vertically elongate cylindrical member. A cooling pipe that constitutes an evaporator of a refrigeration circuit is wrapped around an outer circumferential surface of the refrigeration casing. An auger that has a helical blade is provided in an inner portion of the refrigeration casing, and ice making water is supplied to the inner portion of the refrigeration casing. Ice that grows on an inner circumferential surface of the refrigeration casing is scraped off by rotation of the helical blade, forming flake ice. The flake ice is conveyed upward by helical action. After forming the flake ice into a desired shape and hardness by using a pressing head disposed on an upper portion of the refrigeration casing, the flake ice is stored within a cylindrical ice storage bin that is disposed above the pressing head.

An upper end portion of the auger extends through the pressing head and into the inside of the ice storage bin. An agitator is attached to the upper end portion. The agitator rotates together with the auger, thus agitating the ice within the ice storage bin. Further, the ice discharge port opens in a side wall portion of the ice storage bin, and a door is attached to the ice discharge port. By opening the door, ice is discharged from the ice storage bin.

As described in JP 2003-176967 A for example, in this type of ice dispenser, when a solenoid is energized in response to the turning on of an ice discharge switch, the door that is connected to a plunger rotates open. The agitator rotates at the same time, and ice is discharged from the ice discharge port to a discharge chute. Further, when the ice discharge switch is turned off, electricity is cut off from the solenoid, and the door is closed by the elastic force of a spring. The discharge of ice thus stops, and rotation of the agitator stops when a full ice state is reached. The agitator continues to rotate during ice making operations, even if the door is closed.

However, the flow of ice discharged from the ice discharge port to the discharge chute is stopped by the door when the ice discharge switch is turned off, and ice A may get trapped between the discharge chute 20 and door 21 as shown in FIG. 6. A gap forms in the periphery of the ice A between a distal end portion of the door 21 and the discharge chute 20 when the ice A is thus trapped. There is the following problem when transitioning to an ice making operation in this state. That is, the agitator rotates together with the auger, and therefore ice B within the ice storage bin 23 will spill out from the ice discharge port 22 through a gap between the distal end portion 21a of the door 21 and the discharge chute 20.

### SUMMARY OF THE INVENTION

The present invention has been made in order to solve the problems described above. An object of the present invention is to provide an ice dispenser capable of preventing ice within an ice storage bin from spilling out through the gap, even when ice has become trapped between a door and an ice chute.

An ice dispenser according to the present invention includes: an ice storage bin in which an ice discharge port is formed; a door that opens and closes the ice discharge port; and a discharge chute to which chip ice is discharged from the ice discharge port when the door is opened, in which the discharge chute includes a projecting portion having a substantially horizontal slope portion and a step portion that is connected to an end portion of the slope portion and extends in a downward direction, and in which the step portion has a height that is greater than the size of the chip ice.

### BRIEF DESCRIPTION OF THE DRAWINGS

In the accompanying drawings:

FIG. 1 is a side sectional view showing the overall structure of an ice dispenser according to an embodiment of the present invention;

FIG. 2 is a side sectional view showing an ice discharge portion of the ice dispenser according to the embodiment of the present invention in a state where a door is open;

FIG. 3 is a side sectional view showing the ice discharge portion in the ice dispenser according to the embodiment of the present invention in a state where a door is closed;

FIG. 4 is a side sectional view showing the vicinity of the door and a discharge chute when ice is trapped in the ice dispenser according to the embodiment of the present invention;

FIG. 5 shows forcible entrapment test results, comparing an ice dispenser according to the embodiment of the present invention with a conventional ice dispenser; and

FIG. 6 is a side sectional view showing the vicinity of a door and a discharge chute when ice is trapped in a conventional ice dispenser.

### DETAILED DESCRIPTION OF THE PREFERRED EMBODIMENTS

Embodiments of the present invention are explained below based on the appended drawings.

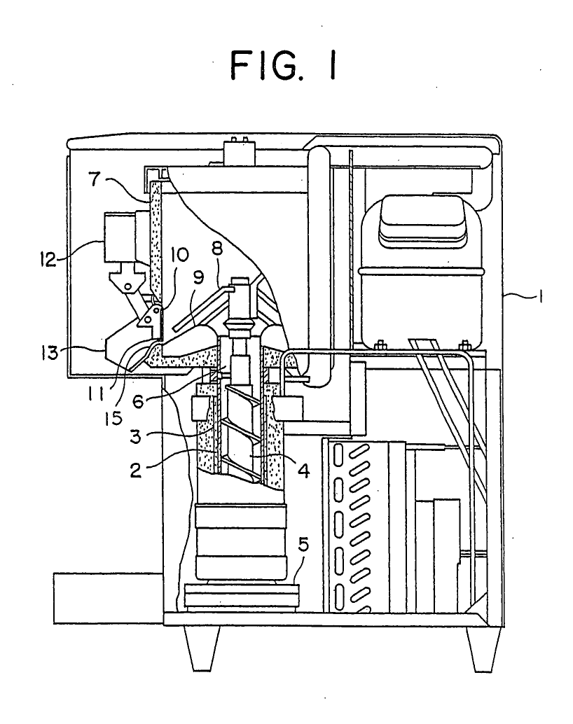

FIG. 1 shows the overall structure of an ice dispenser according to an embodiment of the present invention. A cylindrical refrigeration casing 2 is arranged upright within a main body 1, and a cooling pipe 3 that constisutes an evaporator of a refrigeration circuit is wrapped around an outer circumferential surface of the refrigeration casing 2. An ice scraping auger 4 having a helical blade is supported in an inner portion of the refrigeration casing 2 so as to be free to rotate. A DC brushless geared motor 5, for example, rotationally drives the ice scraping auger 4.

A pressing head 6 that forms ice into a desired shape and hardness is disposed in an upper portion of the refrigeration casing 2. In addition, a circular cylinder shape ice storage bin 7 is disposed above the pressing head 6. An upper end portion of the auger 4 extends through the pressing head 6 and into the inside of the ice storage bin 7. An agitator 8 is attached to the upper end portion of the auger 4, and is adapted to rotate within the ice storage bin 7 together with the auger 4. A drain board 9 that slopes downward toward an outer peripheral portion is laid out on a bottom portion of the ice storage bin 7.

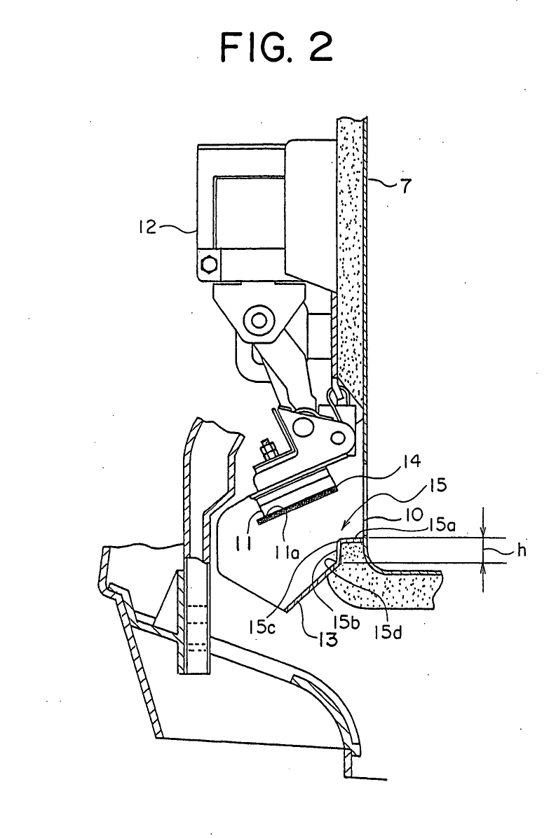

Referring to FIG. 2, an ice discharge port 10 opens in a side wall portion of the ice storage bin 7, and a door 11 is attached to the ice discharge port 10. The door 11 is opened and closed by an opening and closing apparatus 12. A cover plate 14 made from a resin is fixed to a surface of the door 11 opposite the ice storage bin 7, and a distal end part having elasticity extends past a distal end portion 11a of the door 11.

Further, a discharge chute 13 extends from a side wall portion of the ice storage bin 7 outside of the ice discharge port 10. A projecting portion 15 is provided in the discharge chute 13. The projecting portion 15 has a substantially horizontal slope portion 15a that is continuous from the ice discharge port 10, and a step portion 15b forward from where an edge portion 15c of the slope portion 15a is bent vertically downward with respect to the slope portion 15a. It should be noted that the height of the step portion 15b, namely a height h between the edge portion 15c of the slope portion 15a and the edge portion 15d of the step portion 15b, is set larger than the size of ice A. In this embodiment the size of the ice is approximately 10×10×10 mm, and the height h of the step portion 15b is set to be approximately 13 mm.

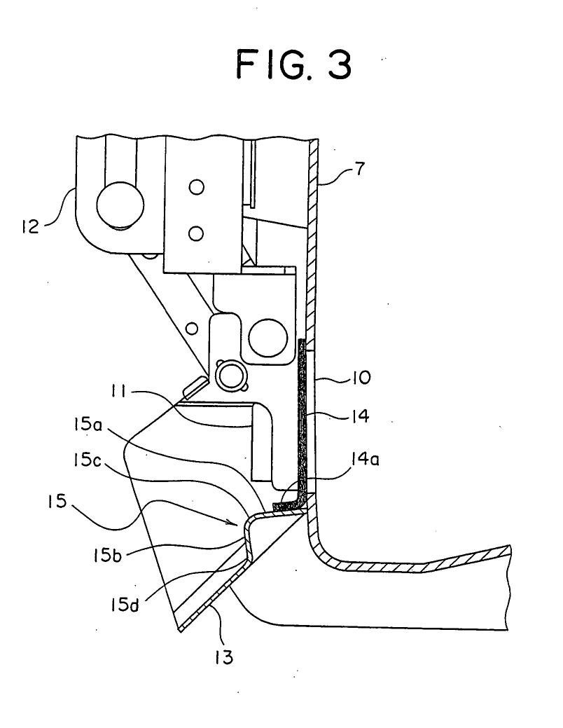

FIG. 3 is a diagram of a state where the door 11 of FIG. 2 is closed. The ice discharge port 10 of the ice storage bin 7 is completely closed by the cover plate 14 that is fixed to the door 11. A distal end part 14a of the cover plate 14 that is longer than the door 11 is bent to contact the slope portion 15a. The projecting portion 15 is provided outside of the ice storage bin 7.

Operation of the ice dispenser according to this embodiment is explained next. Referring to FIG. 1, first the refrigeration circuit is operated. The cooling pipe 3 cools ice making water that is supplied within the refrigeration casing 2, forming ice on an inner circumferential surface of the refrigeration casing 2. The geared motor 5 is driven, and the helical blade of the rotating auger 4 scrapes the ice from the inner circumferential surface of the refrigeration casing 2. The ice thus scraped off is then conveyed to the upper portion of the refrigeration casing 2 by the helical blade, formed into a desired shape and hardness by the pressing head 6, and stored within the ice storage bin 7.

The ice thus stored within the ice storage bin 7 in a chip-like form, for example, is agitated by the agitator 8, which rotates together with the auger 4, and moves in a rotating manner within the ice storage bin 7.

When an ice discharge switch (not shown) provided to the main body 1 is turned on, the door 11 is opened to open the ice discharge port 10, the ice moving in a rotating manner within the ice storage bin 7 due to the agitator 8 is guided to the ice discharge port 10 while sliding along the slope surface of the drain board 9 in an outer circumferential direction, and is discharged from the discharge chute 13.

When the door 11 is closed by turning the ice discharge switch off, the door 11 blocks the flow of ice discharged from the ice discharge port 10 to the discharge chute 13.

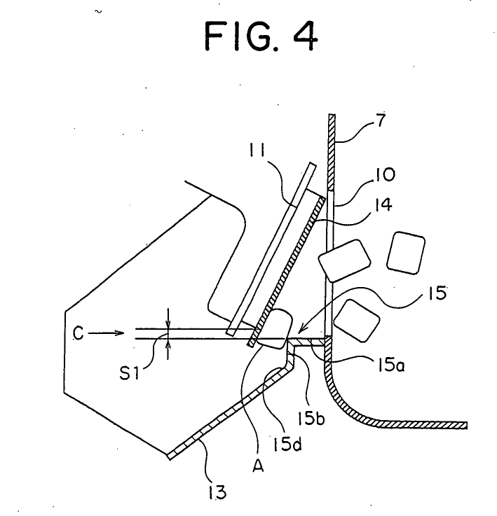

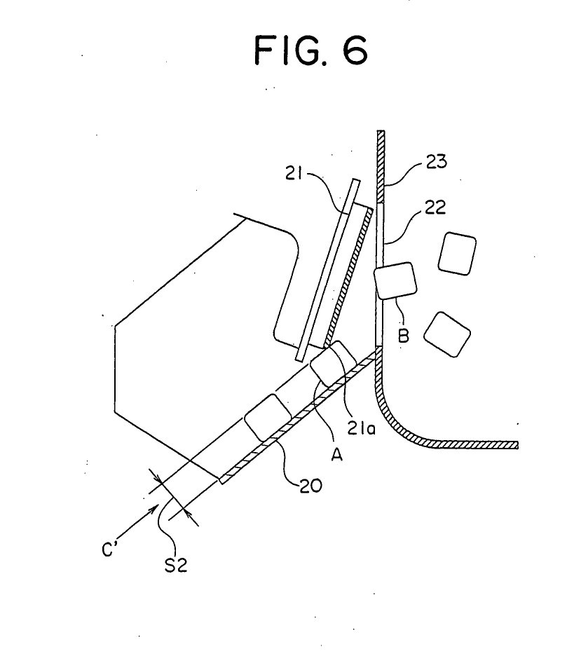

Referring to FIG. 4, the ice A is sandwiched between the distal end of the door 11 and the projecting portion 15 at this point, causing the ice A to become trapped. However, a width S1 as seen from the direction of an extension line of the slope portion 15a (the direction of arrow C) is narrower than a width S2 (opening as seen from the direction of arrow C′) in a conventional apparatus shown in FIG. 6. It thus becomes more difficult for ice to drop down therethrough.

Further, the slope portion 15a is substantially horizontal, and the speed of ice discharged from within the ice storage bin 7 does not increase greatly. The ice can thus be prevented from spilling out.

In addition, the step portion 15b is vertical, so that trapped ice tends to drop down easily, thus keeping the ice from being trapped continuously.

It should be noted that according to the present invention, by solely employing a simple structure in which the projecting portion 15 is provided to the discharge chute, it becomes more difficult for ice to spill out even if ice becomes trapped. The present invention is thus extremely simple and low cost in construction, and is suitable for ice dispensers appearing on the marketplace.

The effect of the ice dispenser according to the present invention, whereby the frequency with which ice spills out is reduced even when ice is trapped between the door 11 and the discharge chute 13, has been confirmed by a forcible entrapment test.

The ice dispenser according to the present invention is the ice dispenser according to this embodiment, shown in FIG. 4. On the other hand the ice dispenser used for comparison is a conventional ice dispenser, shown in FIG. 6.

First, the method of conducting the forcible entrapment test is explained using the ice dispenser of FIG. 4.

The forcible entrapment test commences in a state where the ice within the ice storage bin 7 fills about 80% of the ice storage bin 7. A plate is brought into contact with a lower end of the discharge chute 13 in a state where the door 11 is closed. The door 11 is then opened with the plate still in contact with the lower end of the discharge chute 13, and ice accumulates on the discharge chute 13. The door 11 is then closed with the plate still in contact, and ice is forcibly trapped between the door 11 and the projecting portion 15. The plate is then removed, and the ice on the discharge chute 13 drops down naturally, and it is then confirmed whether or not ice continues to be trapped. If the ice continues to be trapped, any ice that spills out is received in a container that is set below the discharge chute 13, and the number of ice pieces received is measured. This operation was performed 50 times.

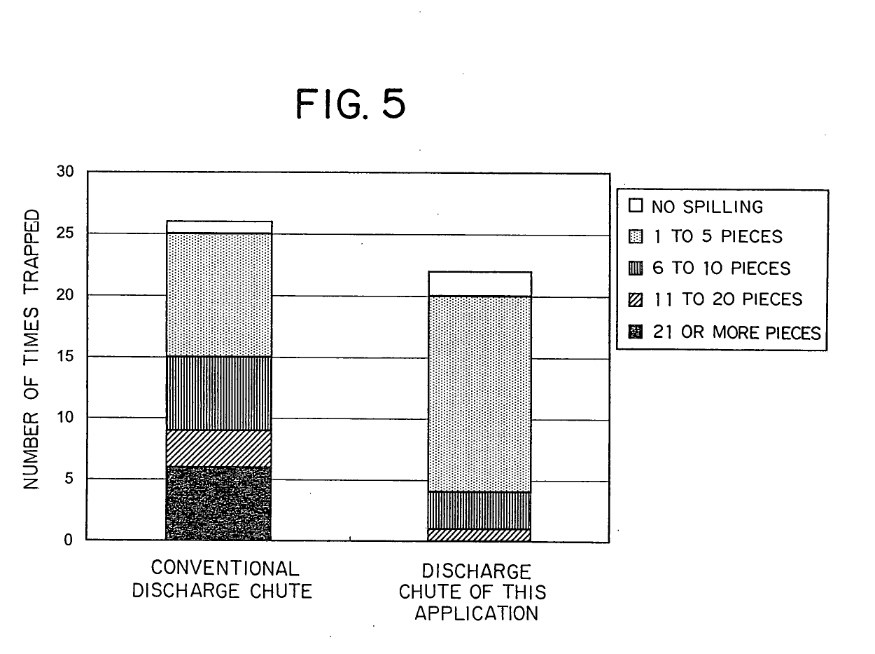

FIG. 5 shows results of the forcible entrapment test. FIG. 5 shows the results of comparison on the number of times ice becomes trapped, and the number of pieces of ice that spilled out when ice became trapped.

The ice dispenser of the present invention had fewer occasions of ice becoming trapped compared to the conventional ice dispenser, and in addition, the number of pieces of ice that spilled out when ice did become trapped was small compared to that of the conventional ice dispenser. From these results it can be seen that providing the protruding portion 15 to the discharge chute 13 leads to an effect whereby the spilling out of ice is suppressed, even when ice become trapped.

The material used for the projecting portion 15 is not limited to a resin material. The projecting portion 15 may also be manufactured by using rubber or a metallic plate, or a combination of these materials.

1. An ice dispenser comprising:
an ice storage bin in which an ice discharge port is formed;
a door that opens and closes the ice discharge port; and
a discharge chute to which chip ice is discharged from the ice discharge port when the door is opened,
wherein the discharge chute comprises a projecting portion having a substantially horizontal slope portion and a step portion that is connected to an end portion of the slope portion and extends in a downward direction, and
wherein the step portion has a height that is greater than a size of the chip ice.

2. An ice dispenser according to claim 1, wherein the step portion extends in a vertical direction.

3. An ice dispenser according to claim 1, wherein the door is provided with a cover plate portion that opposes the ice discharge port, and wherein a lower end portion of the cover plate elastically bends over the slope portion of the projecting portion when the door closes the ice discharge port.
